(19) United States
(12) Patent Application Publication
(10) Pub. No.: US 2017/0045383 A1
(43) Pub. Date: Feb. 16, 2017

(54) MEASUREMENT SENSOR

(71) Applicant: SC2N, Creteil (FR)

(72) Inventors: Olivier Gueguen, Caen (FR); Mathieu Gronier, Saint-Germain-Le-Vasson (FR)

(73) Assignee: SC2N, Creteil (FR)

(21) Appl. No.: 15/104,019

(22) PCT Filed: Dec. 11, 2014
(86) PCT No.: PCT/FR2014/053275

§ 371 Date: Oct. 27, 2016

(30) Foreign Application Priority Data
Dec. 12, 2013 (FR) 1362500
Dec. 12, 2013 (FR) 1362501

(51) Int. Cl. G01D 11/24; B05D 1/32; B05D 1/40; G01K 1/08; G01L 19/14

(52) U.S. Cl. CPC G01D 11/245; G01K 1/08; G01L 19/141; B05D 1/40; B05D 1/32

(57) ABSTRACT

The invention concerns a measurement sensor 1, comprising:—a cavity 1a in which there are arranged at least one sensitive component 2 and at least one measuring component 3, the cavity 1a receiving a coating material 4, in particular a resin, covering the sensitive component 2 and leaving the measuring component 3 at least partially uncovered,—a depositing basin for depositing 1b the coating material 4, communicating with the cavity 1a such that, after the material 4 has been deposited in the basin b, the coating material 4 is allowed to flow into the cavity 1a, the depositing 1b basin having a volume chosen so as to enable it to receive all the coating material 4 when the material 4 is deposited, the basin b being at least partially emptied after the coating material 4 has flowed into the cavity 1a.

The present invention relates to a measurement sensor and, in particular, to a pressure and/or temperature sensor.

In general, measurement sensors include various sensitive components such as printed circuits, for example, that have to be protected from outside attacks by a coating material, typically a thermosetting resin. For example, in the case of a pressure and temperature sensor used in an intake manifold, the components have to be protected against acid attacks by condensates (acids, sulfides, . . . ) originating from the combustion of the fuel.

FIG. 1 diagrammatically illustrates a vertical section of a measurement sensor 1 of the prior art. The sensor 1 includes a cavity 1a, an injection opening 1b for coating material, the opening being arranged above the cavity 1a and leading into the cavity 1a, as well as an air discharge area 1c leading into the cavity 1a.

In the cavity 1a, a sensitive component is arranged, which is, for example, a printed circuit 2, and on the printed circuit 2, a pressure measuring component 3 is arranged in the alignment of the air discharge area 1c. The air discharge area 1c is arranged opposite the component 3 so as to enable the component 3 to perform a measurement.

FIG. 1 shows the start of the injection of a coating material 4, typically a thermosetting coating material, such as, for example, a liquid thermosetting resin, which is used for coating the printed circuit 2. A mixture of a single- or two-component thermosetting coating material (a resin with a hardening agent) can be injected. The resin 4 is injected through the opening 1b and it flows by gravity into the cavity 1a.

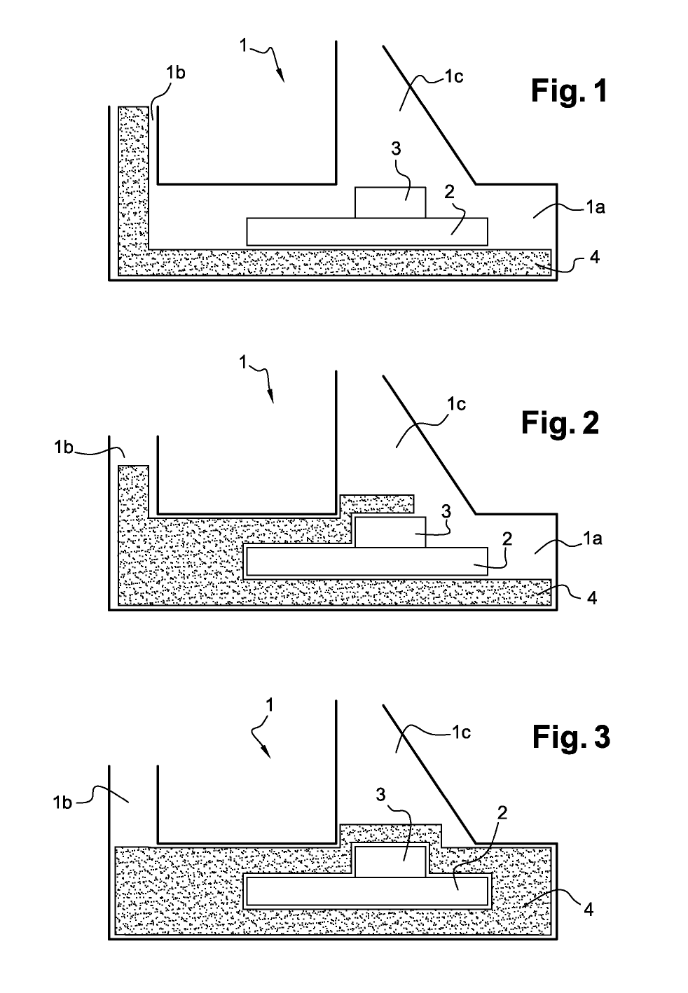

At the end of the injection of the resin 4, as illustrated in FIG. 2, in which the elements that are identical to those in FIG. 1 bear the same reference numerals, the resin 4 has flowed into the cavity 1a and covers the printed circuit 2. When the resin 4 is injected, there is a risk that it may cover the component 3. But if the measuring component 3 is covered with resin 4, it no longer works. This covering of the component 3 can, for example, be due to the local presence of a wave formed by the resin during the flow thereof. This risk can be promoted, worsened under certain conditions of injection pressure of the resin and/or can be due to the viscosity of said resin. These injection parameters are difficult to control, which makes the method for producing such sensors complex and expensive.

FIG. 3 illustrates the final state of the measurement sensor 1, when all the resin 4 has flowed into the cavity 1a. At equilibrium, the resin 4 here covers the measuring component 3 completely, making the pressure measurement impossible.

The present invention aims to remedy these disadvantages.

In particular, the invention proposes a measurement sensor that makes it possible to avoid even a temporary covering of the measuring components by the coating material for the sensitive components, after the injection of the coating material.

Thus, the invention relates to a measurement sensor including:
a cavity in which at least one sensitive component and at least one measuring component are arranged, the cavity receiving a coating material, in particular a resin, covering the sensitive component and leaving the measuring component at least partially uncovered,
a depositing basin for depositing the coating material, communicating with the cavity in such a manner that, after the deposition of the material in the basin, the coating material is allowed to flow into the cavity.

According to the invention, the depositing basin has a volume chosen so as to enable it to receive all the coating material when the material is deposited, the basin being at least partially emptied after the coating material has flowed into the cavity. Such a basin makes it possible to receive all the coating material even before it flows into the interior of the cavity. Thus, the material can flow by simple gravity and avoid creating a wave, the wave being capable of covering the measuring component. The method for producing such a sensor comprising such a basin makes it possible to prevent the use of an injection of materials simultaneously with the flow.

The sensor can include:
at least one opening (1c) communicating with the cavity (1a) and arranged opposite the measuring component (3) in order to enable the measuring component (3) to perform a measurement,
at least one venting opening (1d) different from the opening (1c) and arranged on the flow path of the coating material (4), so as to enable a venting of at least a portion of the air present in the cavity (la) during the flow of the coating material (4).

The effect of such an opening is to allow a venting of at least a portion of the air present in the cavity, at said opening. This makes it possible to promote the venting of the cavity when the coating material penetrates into this cavity. This venting can advantageously be carried out locally in the area in which a wave can have the consequence of covering the measuring component.

In other words, such an opening makes it possible to sensibly locate the area in which the venting is carried out.

The coating material, in particular the resin, can be chosen from the group consisting of a single- or two-component epoxy, silicone or polyurethane resin.

The number of venting openings can be at least equal to two, in particular equal to 3, for example, equal to 4.

The diameter of the venting opening can be between 0.2 mm and 10 mm, in particular between 05 mm and 3 mm.

The venting opening can be formed at one end by a vent column of the sensor, enabling the coating material to rise due to capillarity during the flow of the coating material.

The venting opening can also be formed by a wall, in particular a flat wall, of the sensor.

The venting opening(s) can be arranged around the measuring component.

The venting opening(s) can be arranged opposite the periphery of the measuring component.

Advantageously, the opening(s) can be arranged opposite an area arranged at a distance between 10 mm and 40 mm from the periphery of the measuring component.

In a variant, the opening(s) can be arranged opposite an area arranged at a distance of at least 10 mm from the periphery of the measuring component, in particular at a distance of at least 40 mm.

The measuring component can be a pressure sensor.

The sensitive component(s) can include a printed circuit.

The sensor can include, in addition, an electrical connector connected to the printed circuit.

The depositing basin can lead into a lateral end of the cavity, so as to enable a horizontal lateral flow of the coating material in the cavity after the injection thereof.

The sensor can include additionally an air discharge area communicating with a cavity. Such an area makes it possible to release the air present in the cavity before the material has flowed into the cavity.

The discharge area can be separate from the basin.

The discharge area can be opposite the measuring component.

The sensor can include additionally a temperature sensor.

The temperature sensor can be partially accommodated in the discharge area.

The sensor can comprise a depositing basin for depositing the coating material, the basin communicating with the cavity so as to allow the flow of the coating material into the cavity.

The venting opening can be separate from the basin and separate from the opening.

The volume of the depositing basin can be between 50 mm³ and 5000 mm³, and, in particular, between 500 mm³ and 2000 mm³, in particular between 850 mm³ and 1200 mm³.

The depositing basin can be separated from the cavity by a perforated partition. Such a partition makes it possible to control the flow rate during the flow of the material.

At the end of the flow of the coating material, a portion of this material can remain in the bottom of the depositing basin.

The depositing basin can be in the form of a shaft provided with vertical walls and having an opening in the lower portion thereof that leads into the cavity.

The invention also relates to a method for filling with coating material, and, in particular, with resin, a measurement sensor described above.

The method according to the invention includes the injection of coating material into the depositing basin.

After the step of injecting coating material, the method can include a step of flow of the coating material into the cavity, leading to an equilibrium position of the coating material in which the coating material covers each sensitive component without covering the measuring component(s), then a step of setting of the coating material.

Other features and advantages of the present invention will become clearer upon reading the following description given as an illustrative and non-limiting example, and made in reference to the appended drawings in which:

FIGS. 1 to 3, already described, are diagrammatic cross-sectional views of a measurement sensor of the prior art during different steps of the filling of the sensor with coating material,

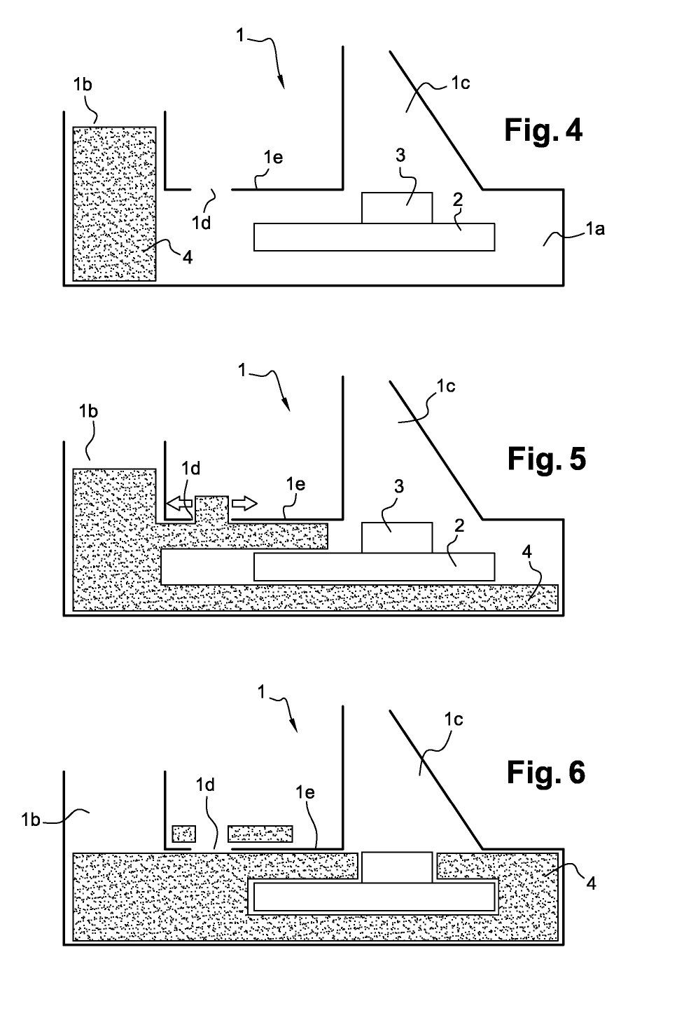

FIGS. 4 to 6 are diagrammatic cross-sectional views of a measurement sensor according to the invention during different steps of filling the sensor with coating material, according to a first embodiment,

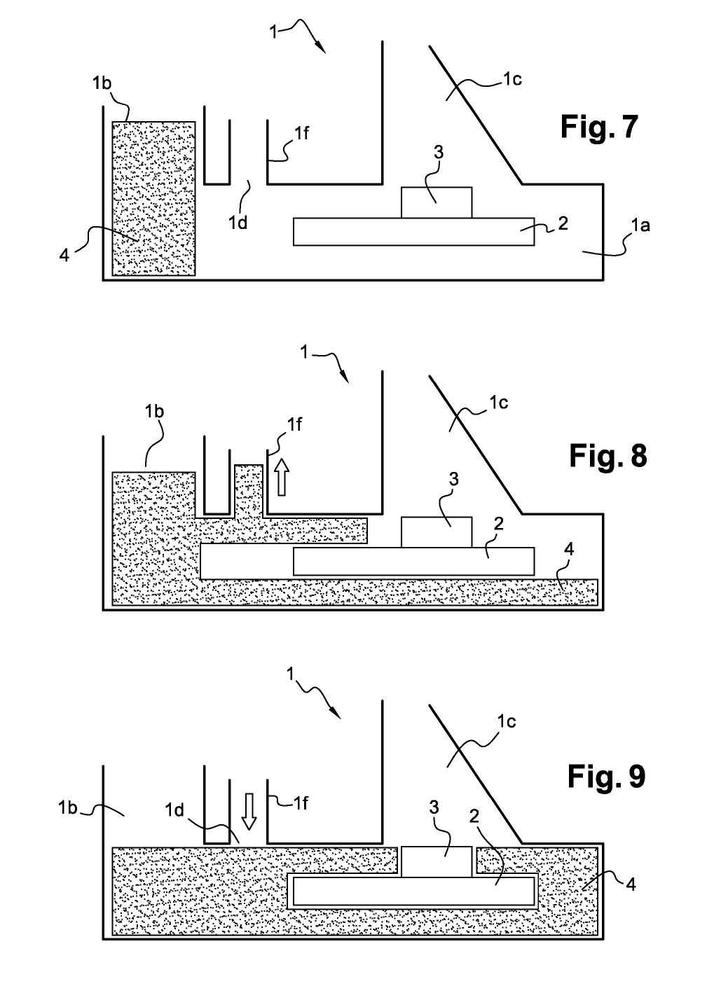

FIGS. 7 to 9 are diagrammatic cross-sectional views of a measurement sensor according to the invention during different steps of filling the sensor with coating material, according to a second embodiment,

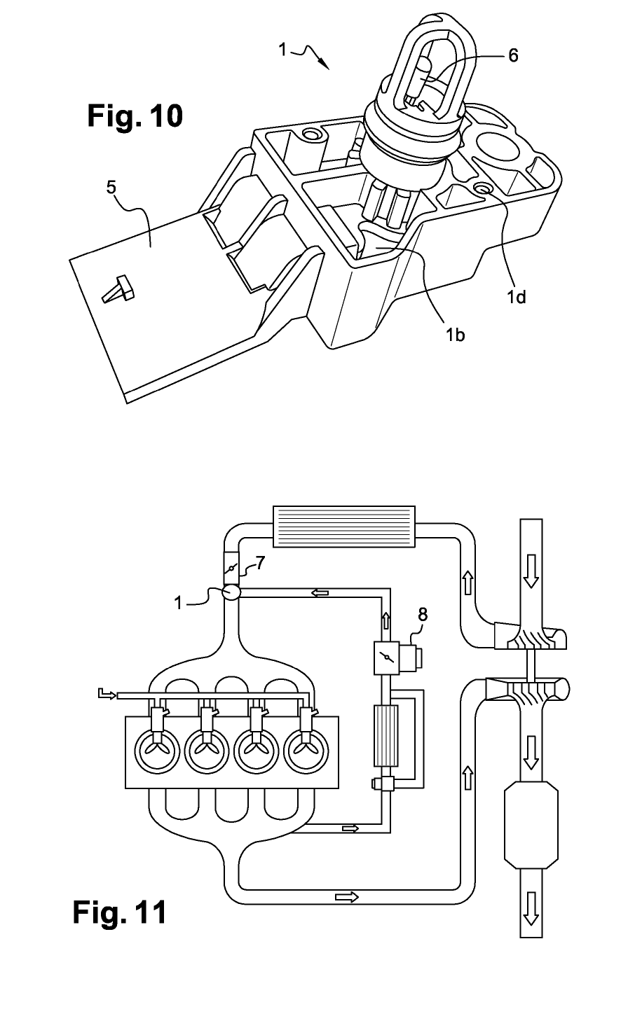

FIG. 10 is a perspective view of the measurement sensor according to the invention, and

FIG. 11 illustrates an implementation example of the sensor according to the invention.

As illustrated in FIG. 4, in which the elements that are identical to those of FIGS. 1 to 3 bear the same reference numerals, a measurement sensor 1 according to the invention is provided with a basin 1b, the volume of which preferably makes it possible to receive all the resin from the start of the injection of said resin. The depositing basin 1b can lead into a lateral end of the cavity 1a.

Thus, during the injection of the resin 4 into the depositing basin 1b, the resin 4 flows by gravity towards the bottom of the cavity 1a.

As represented in FIG. 5, the resin 4 is in the process of flowing horizontally and laterally into the remainder of the cavity 1a.

The sensor 1 here includes a venting opening 1d communicating with the cavity. This opening, which is separate from the opening 1c, is arranged on the flow path of the resin 4, thereby enabling a venting of at least a portion of the air present in the cavity 1a during the flow of the resin 4. During this venting of air, the resin 4 which is found at the site of the opening 1d is discharged via the opening 1d, which makes it possible to prevent the covering of a measuring component 3, for example, an electronic measuring component such as a sensor, by the resin 4 during the flow of the resin 4. According to a first embodiment as illustrated in FIG. 5, the venting opening 1d, which can be circular, is formed in a wall 1e, in particular a flat and horizontal wall, of the sensor 1. The resin 4 is discharged around the opening 1d, on the upper surface of the wall 1e.

FIG. 6 illustrates the final state of the measurement sensor 1, when all the resin 4 has flowed into the cavity 1a. At equilibrium, the resin 4 is arranged above and below the printed circuit 2 but does not cover the upper surface of the measuring component 3, which is opposite the surface by which it is in contact with the circuit 2, thereby enabling the pressure measurement. The resin 4 also remains around the opening 1d, on the upper surface of the wall 1e.

The method ends with the setting of the resin 4.

In a second embodiment, as illustrated in FIGS. 7 to 9, in which the identical elements bear the same reference numerals, the venting opening 1d is formed at an end of a vent column 1f of the sensor 1, allowing the resin 4 to rise by capillarity (FIG. 8), then descend again due to the action of gravity (FIG. 9), during the flow of the resin 4. The vent column 1f can be cylindrical. Here too, the presence of the vent column(s) if allows a flow of resin 4 that does not lead to a covering of the measuring component 3.

In this last embodiment, the vent column if additionally makes it possible to guide a resin excess out of the cavity during the flow of the resin into the cavity. This resin excess can then return to the cavity due to gravity, when all the resin has flowed from the basin into the cavity.

FIG. 10 is a detailed view of the measurement sensor 1. The sensor 1 can include an electrical connection area 5 which is used for being connected to the printed circuit 2, as well as a temperature sensor 6, which is typically placed in the opening 1c.

The measurement sensor 1 according to the invention can be of any sensor type having sensitive elements that have to be covered with coating material in a closed cavity. The measurement sensor 1 can be used, in particular, for measuring the air volume that will be mixed with gasoline in a system for recirculating exhaust gases, downstream of an air intake throttle valve 7 as illustrated in FIG. 11. The principle of a system for recirculating exhaust gases, also called EGR for “Exhaust Gas Recirculation” in the English language, consists in collecting a portion of the exhaust gases, comprising inert gases, in order to recirculate it in the intake circuit by means of an EGR valve 8. The presence in an intake area of inert gases of the exhaust gases makes it possible to slow the rate of combustion and to absorb the calories, and thus it results in a lowering of the emission of nitrogen oxides.

1. A measurement sensor comprising:
a cavity in which at least one sensitive component and at least one measuring component are arranged, the cavity receiving a coating material comprising a resin, covering the sensitive component and leaving the measuring component at least partially uncovered; and
a depositing basin for depositing the coating material, communicating with the cavity in such a manner that, after the material has been deposited in the basin, the coating material is allowed to flow into the cavity,
the depositing basin having a volume chosen so as to enable it to receive all the coating material when the material is deposited, the basin being at least partially emptied after the coating material has flowed into the cavity.

2. The sensor according to claim 1, further comprising:
at least one opening communicating with the cavity and arranged opposite the measuring component in order to enable the measuring component to carry out a measurement; and
at least one venting opening separate from the opening, arranged on the flow path of the coating material, in such manner as to enable a venting of at least a portion of the air present in the cavity during the flow of the coating material.

3. The sensor according to claim 2, in which the number of venting openings is at least equal to two.

4. The sensor according to claim 2, wherein the diameter of the venting opening is between 0.5 mm and 3 mm.

5. The sensor according to claim 2, in which the venting opening is formed at one end by a vent column of the sensor enabling the coating material to rise by capillarity during the flow of the coating material.

6. The sensor according to claim 2, in which the venting opening is formed by a flat wall, of the sensor.

7. The sensor according to claim 1, in which the measuring component is a pressure sensor.

8. The sensor according to claim 1, in which the sensitive component(s) include(s) a printed circuit.

9. The sensor according to claim 8, including moreover an electrical connector connected to the printed circuit.

10. The sensor according to claim 1, wherein the depositing basin leads into a lateral end of the cavity, in such a manner as to enable a horizontal lateral flow of the coating material in the cavity after the injection thereof.

11. The sensor according to claim 1, further comprising an air discharge area communicating with the cavity.

12. The sensor according to claim 1, further comprising a temperature sensor.

13. The sensor according to claim 1, in which the volume of the depositing basin is between 850 mm³ and 1200 mm³.

14. The sensor according to claim 1, in which the depositing basin is separated from the cavity by a perforated partition.

15. The sensor according to claim 1, wherein, at the end of the flow of coating material, a portion of said material remains in the bottom of the depositing basin.

16. The sensor according to claim 1, in which the depositing basin is in the shape of a shaft provided with vertical walls and. having an opening in the lower portion thereof that leads into the cavity.

17. A method for filling with coating material a measurement sensor as claimed in claim 1, the method comprising:
injecting coating material into the depositing basin.

18. The method according to claim 17, further comprising, after the step of injection of coating material
flowing of the coating material into the cavity, leading to an equilibrium position of the coating material in which the coating material covers each sensitive component without covering the measuring component(s); and then
curing of said coating material.
